(19) United States
(12) Patent Application Publication
(10) Pub. No.: US 2019/0284871 A1
(43) Pub. Date: Sep. 19, 2019

(54) GLARE SENSOR THAT IDENTIFIES POTENTIAL GLARE SOURCES IN DIGITAL IMAGES AND COMPUTES THEIR COORDINATES TO HELP CONTROL DYNAMIC WINDOW AND SKYLIGHT SYSTEMS

(71) Applicant: The Regents of the University of California, Oakland, CA (US)

(72) Inventor: Konstantinos Papamichael, Davis, CA (US)

(73) Assignee: The Regents of the University of California, Oakland, CA (US)

(21) Appl. No.: 16/087,998

(22) PCT Filed: Apr. 24, 2017
(86) PCT No.: PCT/US2017/029147

§ 371 Date: Sep. 24, 2018

Related U.S. Application Data
(60) Provisional application No. 62/328,931, filed on Apr. 28, 2016.

(51) Int. Cl. E06B 9/262; E06B 9/68

(52) U.S. Cl. CPC E06B 9/262; E06B 9/40; E06B 2009/6827; E06B 9/68

(57) ABSTRACT

The disclosed embodiments relate to the design of a system that controls a dynamic-shading system for a window/skylight. This system includes a photosensor array, and an optical element having a field of view corresponding to the window/skylight, which directs light onto the photosensor array. It also includes a processing mechanism that automatically generates a digital luminance map from signals received through the photosensor array to determine locations of one or more light sources in the field of view. The processing mechanism also automatically controls the dynamic-shading system in response to the determined locations of the one or more light sources.

### CROSS-REFERENCE TO RELATED APPLICATION

This application claims the benefit of U.S. Provisional Application Ser. No. 62/328,931, entitled “Glare Sensor Based on Luminance Maps Generated through Digital Imaging for Use with Dynamic Window and Skylight Systems,” by inventor Konstantinos Papamichael, Attorney Docket Number UC16-713-1PSP, filed on 28 Apr. 2016, the contents of which are incorporated by reference herein.

### BACKGROUND

### Field

The disclosed embodiments generally relate to shading systems for windows and skylights, such as dynamic glazings, Venetian blinds, vertical louvers and rolling shades. More specifically, the disclosed embodiments relate to the design of an automated glare sensor, which determines the direction of incoming direct or reflected sunlight to facilitate control of dynamic-shading systems for windows and skylights.

### Related Art

Advances in home automation have led to the development of dynamic glazings and shading systems, such as Venetian blinds and roller shades, which automatically adjust their state to selectively cover windows or skylights in response to changes in incident sunlight.

However, the task of operating a dynamic-shading system to control the inflow of solar radiation into a window or a skylight requires knowledge of the position of the sun relative to the window or skylight. Traditional approaches for determining the sun's position rely on information about: the latitude and the longitude of the location of the installation; the window or skylight's orientation; and the time of day. Some systems also account for external obstructions that can block direct solar radiation, which requires additional information about the geometry of the external obstructions, and their relation to the window or skylight. However, these traditional approaches do not account for cases where reflected, rather than direct solar radiation, is incident on the window or skylight. For example, see FIG. 1A, which illustrates how both direct sunlight 106 and reflected sunlight 108 can be directed to window 105 in a building 104, and FIG. 1B, which illustrates how reflected sunlight can be directed to window 105 through reflection from a building 120. Existing systems do not detect such direct sunlight 106 and reflected sunlight 108 and 110.

Hence, what is needed is a technique for controlling dynamic window and skylight systems, which accounts for reflected as well as direct solar radiation that can cause glare through windows and skylights.

### SUMMARY

The disclosed embodiments relate to the design of a system that controls a dynamic-shading system for a window/skylight. This system includes a photosensor array, and an optical element having a field of view corresponding to the window/skylight, which directs light onto the photosensor array. It also includes a processing mechanism that automatically generates a digital image from signals received through the photosensor array to determine locations of one or more light sources in the field of view, as well as their directional coordinates. The processing mechanism also automatically controls the dynamic-shading system in response to the determined locations of the one or more light sources.

In some embodiments, the one or more light sources can include: a source of direct light; and/or a source of reflected light.

In some embodiments, the optical element can include a lens, or a diffraction grating of known projection of its spherical view on the photosensor array.

In some embodiments, the processing mechanism determines polar coordinates specifying locations for the one or more light sources in the field of view.

In a variation on these embodiments, the polar coordinates for a given light source include: a left azimuth angle for the light source; a right azimuth angle for the light source; a top elevation angle for the light source; and a bottom elevation angle for the light source.

In some embodiments, the processing mechanism determines Cartesian coordinates specifying locations for the one or more light sources in the field of view.

In some embodiments, during an energy-efficiency mode, the processing mechanism controls the dynamic-shading system to optimize energy efficiency.

In some embodiments, the processing mechanism determines the profile angle of one or more light sources in the field of view of the window or skylight.

In some embodiments, during a glare-elimination mode, the processing mechanism controls the dynamic-shading system to eliminate glare from the one or more light sources.

In some embodiments, the dynamic-shading system comprises one or more of the following: a roll-up shade; a roll-down shade; a Venetian blind; a vertical louver shade; a horizontal louver shade; a pleated shade; a Roman shade; a cellular shade; a retractable awning;

an adjustable curtain; an adjustable drape; and an electrochromic glass window.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1A illustrates how direct and reflected solar radiation can enter a window in accordance with the disclosed embodiments.

FIG. 1B illustrates how solar radiation reflected off a building can enter a window in accordance with the disclosed embodiments.

FIG. 2 illustrates an exemplary system that uses a glare sensor to control a window shade in accordance with the disclosed embodiments.

FIG. 3A illustrates the design of a glare sensor in accordance with the disclosed embodiments.

FIG. 3B illustrates different projections for the glare sensor in accordance with the disclosed embodiments.

FIG. 4 presents a luminance map generated by the glare sensor in accordance with the disclosed embodiments.

FIG. 5A illustrates an image captured by the glare sensor, wherein the glare sensor has not identified any light sources that have the potential for glare (using a variable to hold a threshold of absolute or relative luminance) in accordance with the disclosed embodiments.

FIG. 5B illustrates an image captured by the glare sensor, wherein the glare sensor identifies a light source that has the potential for glare (a desk lamp turned on) and returns the bounding polar coordinates of its area in accordance with the disclosed embodiments.

FIG. 6 presents a flow chart illustrating operations performed by a system for controlling a window/skylight in accordance with the disclosed embodiments.

FIG. 7 illustrates a computer system (microprocessor) that implements a controller for the window/skylight system in accordance with an embodiment of the present disclosure.

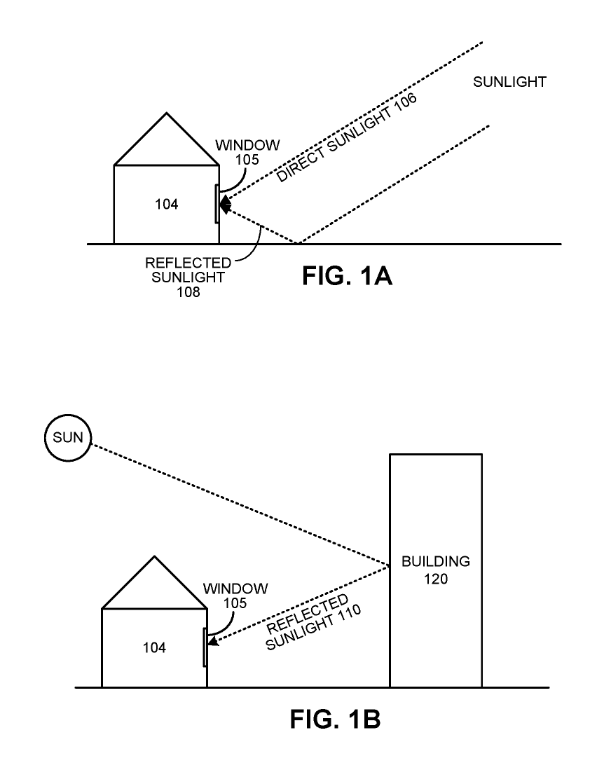

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### Overview

In the disclosed embodiments, a glare sensor is integrated into a window or a skylight to facilitate automatic adjustment of dynamic-shading systems, such as Venetian blinds, vertical louvers, and roll-down/up shades. This glare sensor comprises a photosensor array covered by an optical element with a known field of view and a known projection. The output of the glare sensor is processed by a controller, which also obtains information about the specific geometry of the dynamic-shading system (e.g., the slat width and the distance between slats for a Venetian blind). During this processing, the controller generates a digital luminance map, which is used to determine spatial variations in luminance. These spatial variations are further processed to determine the position of one or more light sources in the field of view of the sensor. This enables the dynamic-shading system to effectively block incoming radiation as indicated by the coordinates of the light sources. The logic controller can additionally use knowledge about the relative position of the sun (or its reflection, or other bright light sources) to determine an optimal adjustment of the dynamic-shading system to block the incoming solar radiation. This glare-sensor-based control system requires no manual input and can account for both direct and reflected solar radiation as it senses (rather than computes) the sun's position by interpreting an image gathered through a window/skylight-facing sensor. Moreover, this glare sensor can be easily attached to windows or skylights that already include dynamic-shading systems, or can be integrated into such systems at the factory.

### Implementation Details

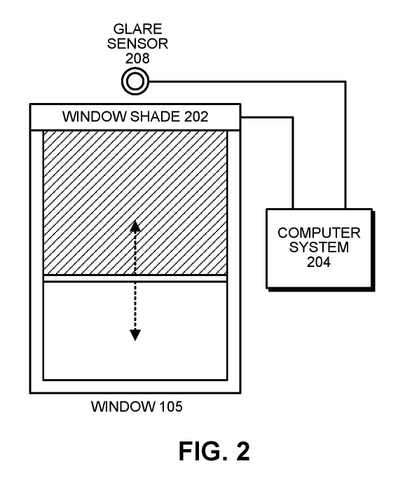

FIG. 2 illustrates an exemplary system that uses a glare sensor 208 to control a window shade 202 in accordance with the disclosed embodiments. As illustrated in FIG. 2, window 105 includes a motorized window shade 202, which can be adjusted to cover some or all of window 105. Note that this system can generally use any type of dynamic-shading system and is not meant to be limited to using a window shade. For example, instead of using a window shade, the system can use: a roll-up shade; a roll-down shade; a Venetian blind; a vertical louver shade; a horizontal louver shade; a pleated shade; a Roman shade; a cellular shade; a retractable awning; an adjustable curtain; an adjustable drape; or an electrochromic window.

Glare sensor 208 is located in proximity to window 105, and is oriented so that the field of view of glare sensor 208 is similar to the field of view of window 105. The output of glare sensor 208 feeds into a computer system 204, which can be implemented using a microprocessor that is integrated into the glare sensor, and which converts the output into a digital luminance map that is used to dynamically control the position of window shade 105.

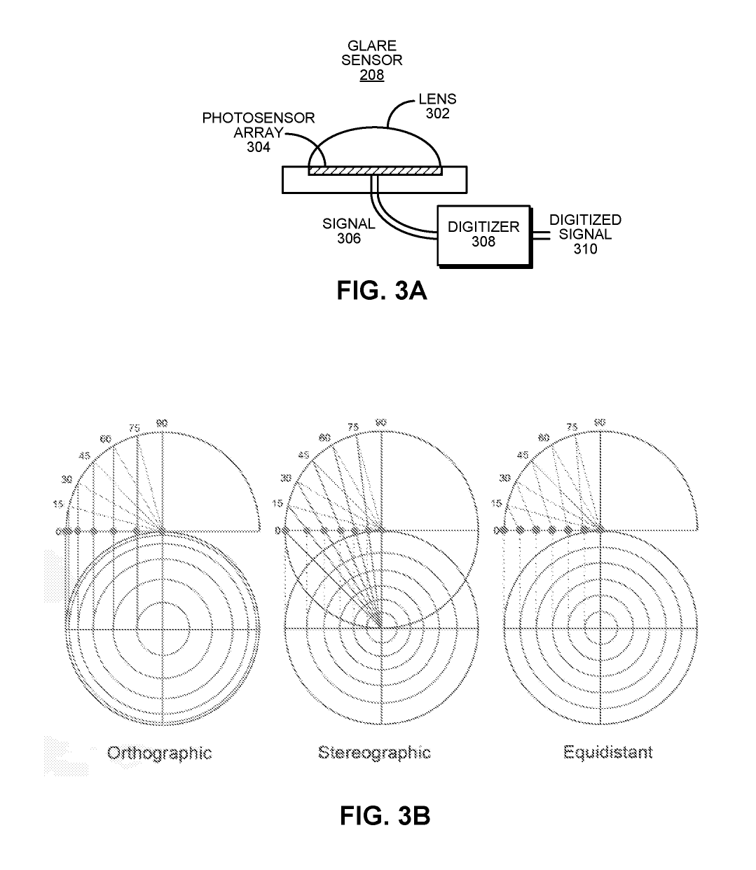

FIG. 3A illustrates an exemplary design for glare sensor 208 in accordance with the disclosed embodiments. As illustrated in FIG. 3A, glare sensor 208 includes a lens 302, which directs light onto the photosensor array 304, such as a charge-coupled device (CCD) array. Photosensor array 304 generates a signal 306, which feeds through a digitizer 308 to produce a digitized signal 310. Finally, digitized signal 310 feeds into computer system 204, which is illustrated in FIG. 2.

FIG. 3B illustrates different possible projections for glare sensor 208 in accordance with the disclosed embodiments. In some embodiments of glare sensor 208, lens 302 produces a hemispherical projection, wherein this hemispherical projection can be an orthographic projection, a stereographic projection or an equidistant projection as is illustrated in FIG. 3B. Note that the glare sensor can generally use any type of known projection, and the three projections illustrated in FIG. 3B are merely examples of common projections.

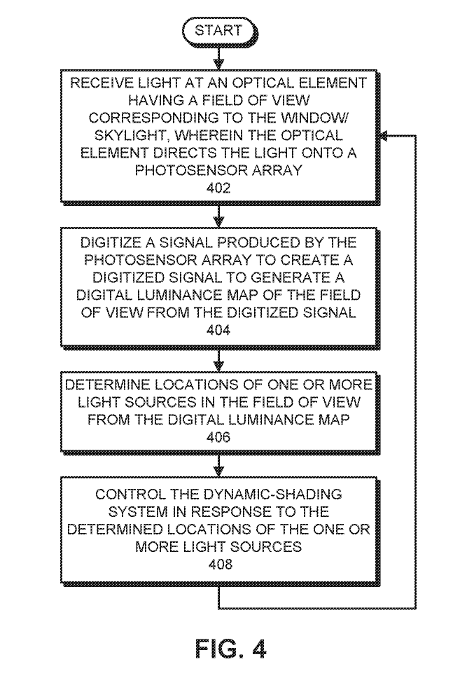

FIG. 4 illustrates an exemplary luminance map generated by glare sensor 208 in accordance with the disclosed embodiments. This luminance map presents a sky dome in a false color display indicating luminance, along with a superimposed equidistant projection of the corresponding polar coordinates. During processing of this luminance map, the system identifies spatial variations in luminance along with coordinates of the brightest areas of the scene.

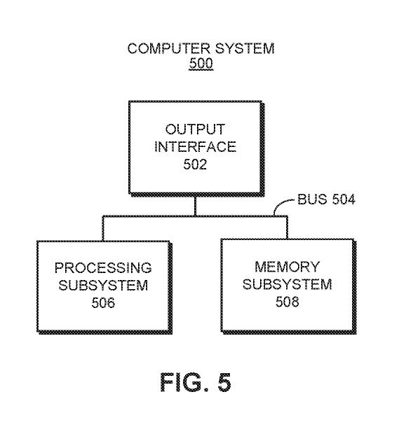

FIGS. 5A and 5B present screenshots obtained from a prototype glare sensor showing the identification of a desk lamp switched OFF in FIG. 5A, and switched ON in FIG. 5B. The upper right-hand corner of FIG. 5B also displays both coordinates that specify the location of the resulting brightest spot in the glare sensor's field of view. These exact values of coordinates are hard to make out from FIG. 5B, but the important point is that they specify the location of the brightest sport in both Cartesian coordinates (in terms of x and y coordinates) and in polar coordinates (in terms of an azimuth and altitude angles).

### Operation of a Control System for a Window/Skylight

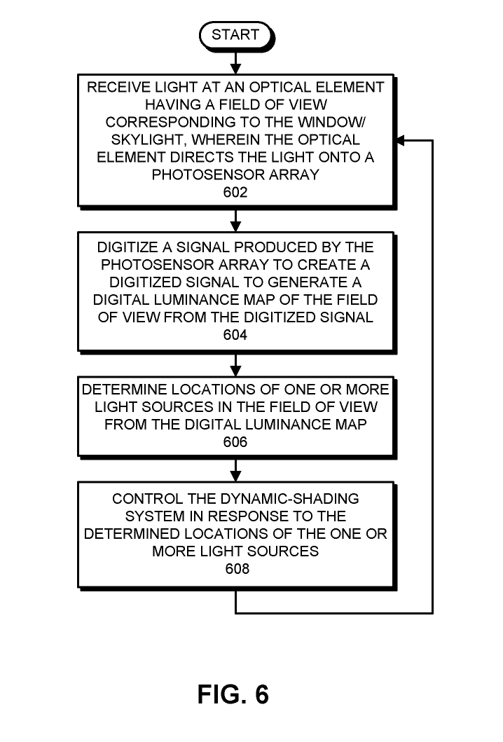

FIG. 6 presents a flow chart illustrating operations performed by a system for controlling a window/skylight in accordance with the disclosed embodiments. First, the system receives light at an optical element having a field of view associated with the window/skylight, wherein the optical element directs the light onto a photosensor array (step 602). Next, the system digitizes a signal produced by the photosensor array to create a digitized signal to generate a digital luminance map of the field of view from the digitized signal (step 604). Next, the system determines locations of one or more light sources in the field of view from the digital luminance map (step 606). Finally, the system controls the dynamic-shading system in response to the determined locations of the one or more light sources (step 608). In some embodiments, during an energy-efficiency mode, the system controls the dynamic-shading system to optimize energy efficiency. In some embodiments, during a glare-elimination mode, the system controls the dynamic-shading system to reduce or eliminate glare from the one or more light sources.

### Computer System

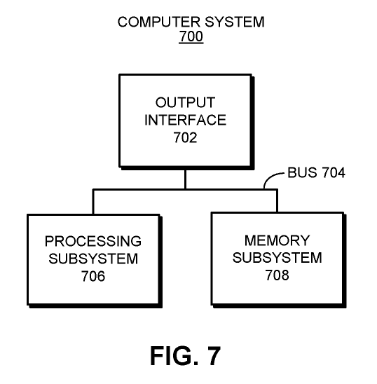

FIG. 7 illustrates an exemplary implementation of computer system 700 (such as computer system 204 illustrated in FIG. 2), which controls operation of the dynamic-shading system. As illustrated in FIG. 7, computer system 700 includes: a processing subsystem 706 with one or more processors, a memory subsystem 708 (with memory), and an output interface 702, which is can be used to send control signals to the window/skylight system.

In general, computer system 700 can be implemented using a combination of hardware and/or software. Thus, computer system 700 may include one or more program modules or sets of instructions stored in a memory subsystem 708 (such as DRAM or another type of volatile or non-volatile computer-readable memory), which, during operation, may be executed by processing subsystem 706. Furthermore, instructions in the various modules in memory subsystem 708 may be implemented in: a high-level procedural language, an object-oriented programming language, and/or in an assembly or machine language. Note that the programming language may be compiled or interpreted, e.g., configurable or configured, to be executed by the processing subsystem.

Components in computer system 700 may be coupled by signal lines, links or buses, for example bus 704. These connections may include electrical, optical, or electro-optical communication of signals and/or data. Furthermore, in the preceding embodiments, some components are shown directly connected to one another, while others are shown connected via intermediate components. In each instance, the method of interconnection, or “coupling,” establishes some desired communication between two or more circuit nodes, or terminals. Such coupling may often be accomplished using a number of photonic or circuit configurations, as will be understood by those of skill in the art; for example, photonic coupling, AC coupling and/or DC coupling may be used.

In some embodiments, functionality in these circuits, components and devices may be implemented in one or more: application-specific integrated circuits (ASICs), field-programmable gate arrays (FPGAs), and/or one or more digital signal processors (DSPs). Furthermore, functionality in the preceding embodiments may be implemented more in hardware and less in software, or less in hardware and more in software, as is known in the art. In general, computer system 700 may be at one location or may be distributed over multiple, geographically dispersed locations.

Computer system 700 may include a computer system (such as a multiple-core processor computer system). Furthermore, the computer system may include, but is not limited to: a server (such as a multi-socket, multi-rack server), a laptop computer, a communication device or system, a personal computer, a work station, a mainframe computer, a blade, an enterprise computer, a tablet computer, a supercomputer, a network-attached-storage (NAS) system, a storage-area-network (SAN) system, a media player (such as an MP3 player), an appliance, a subnotebook/netbook, a tablet computer, a smartphone, a cellular telephone, a network appliance, a set-top box, a personal digital assistant (PDA), a toy, a controller, a digital signal processor, a game console, a device controller, a computational engine within an appliance, a consumer-electronic device, a portable computing device or a portable electronic device, a personal organizer, and/or another electronic device.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. A system that controls a dynamic-shading system for a window/skylight, comprising:
a photosensor array;
an optical element having a field of view corresponding to the window/skylight, which directs light onto the photosensor array; and
a processing mechanism that automatically:
generates a digital luminance map from signals received through the photosensor array to determine locations of one or more light sources in the field of view; and
controls the dynamic-shading system in response to the determined locations of the one or more light sources.

2. The system of claim 1, wherein the one or more light sources can include:
a source of direct light; and/or
a source of reflected light.

3. The system of claim 1, wherein the optical element can include one of:
a lens; and
a diffraction grating.

4. The system of claim 1, wherein the processing mechanism determines polar coordinates specifying locations for the one or more light sources in the field of view.

5. The system of claim 4, wherein the polar coordinates for a given light source include:
a left azimuth angle for the light source;
a right azimuth angle for the light source;
a top elevation angle for the light source; and
a bottom elevation angle for the light source.

6. The system of claim 1, wherein the processing mechanism determines Cartesian coordinates specifying locations for the one or more light sources in the field of view.

7. The system of claim 1, wherein during a glare-elimination mode, the processing mechanism controls the dynamic-shading system to eliminate glare from the one or more light sources.

8. The system of claim 1, wherein the dynamic-shading system comprises one or more of the following:
a roll-up shade;
a roll-down shade;
a Venetian blind;
a vertical louver shade;
a horizontal louver shade;
a pleated shade;
a Roman shade;
a cellular shade;
a retractable awning;
an adjustable curtain;
an adjustable drape; and
an electrochromic window.

9. A dynamic-shading system for a window/skylight, comprising:
a dynamic shade that selectively covers the window/skylight; and
a controller for the dynamic shade, comprising:
a photosensor array;
an optical element having a field of view corresponding to the window/skylight, which directs light onto the photosensor array; and
a processing mechanism that automatically:
generates a digital luminance map from signals received through the photosensor array to determine locations of one or more light sources in the field of view; and
controls the dynamic shade in response to the determined locations of the one or more light sources.

10. The dynamic-shading system of claim 9, wherein the one or more light sources can include:
a source of direct light; and/or
a source of reflected light.

11. The dynamic-shading system of claim 9, wherein the optical element can include one of:
a lens; and
a diffraction grating.

12. The dynamic-shading system of claim 2, wherein the processing mechanism determines polar coordinates specifying locations for the one or more light sources in the field of view.

13. The dynamic-shading system of claim 12, wherein the polar coordinates for a given light source include:
a left azimuth angle for the light source;
a right azimuth angle for the light source;
a top elevation angle for the light source; and
a bottom elevation angle for the light source.

14. The dynamic-shading system of claim 9, wherein the processing mechanism determines Cartesian coordinates specifying locations for the one or more light sources in the field of view.

15. The dynamic-shading system of claim 9, wherein during a glare-elimination mode, the processing mechanism controls the dynamic shade to eliminate glare from the one or more light sources.

16. The dynamic-shading system of claim 9, wherein the dynamic shade comprises one or more of the following:
a roll-up shade;
a roll-down shade;
a Venetian blind;
a vertical louver shade;
a horizontal louver shade;
a pleated shade;
a Roman shade;
a cellular shade;
a retractable awning;
an adjustable curtain;
an adjustable drape; and
an electrochromic window.

17. A method for controlling a dynamic-shading system for a window/skylight, comprising:
receiving light at an optical element having a field of view associated with the window/skylight, wherein the optical element directs the light onto a photosensor array;
digitizing a signal produced by the photosensor array to create a digitized signal;
generating a digital luminance map of the field of view from the digitized signal;
determining locations of one or more light sources in the field of view from the digital luminance map; and
controlling the dynamic-shading system in response to the determined locations of the one or more light sources.

18. The method of claim 17, wherein the one or more light sources can include:
a source of direct light; and/or
a source of reflected light.

19. The method of claim 17, wherein the optical element can include one of:
a lens; and
a diffraction grating.

20. The method of claim 17, wherein while determining the locations of the one or more light sources in the field of view, the processing mechanism determines polar coordinates specifying locations for the one or more light sources.

21. The method of claim 20, wherein the polar coordinates for a given light source include:
a left azimuth angle for the light source;
a right azimuth angle for the light source;
a top elevation angle for the light source; and
a bottom elevation angle for the light source.

22. The method of claim 17, wherein while determining the locations of the one or more light sources in the field of view, the processing mechanism determines Cartesian coordinates specifying locations for the one or more light sources.

23. The method of claim 17, wherein during a glare-elimination mode, the processing mechanism controls the dynamic-shading system to eliminate glare from the one or more light sources.

24. The method of claim 17, wherein the dynamic-shading system comprises one or more of the following:
a roll-up shade;
a roll-down shade;
a Venetian blind;
a vertical louver shade;
a horizontal louver shade;
a pleated shade;
a Roman shade;
a cellular shade;
a retractable awning;
an adjustable curtain;
an adjustable drape; and
an electrochromic window.
